(19) United States
(12) Patent Application Publication
(10) Pub. No.: US 2005/0219270 A1
(43) Pub. Date: Oct. 6, 2005

(54) Display of high quality pictures on a low performance display

(76) Inventors: Petrus Maria De Greef, Eindhoven (NL); Rob Anne Beuker, Eindhoven (NL); Petrus Adrianus Maria Van De Sande, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/507,949

(22) PCT Filed: Feb. 25, 2003
(86) PCT No.: PCT/IB03/00761

§ 371 Date: Sep. 14, 2004

(30) Foreign Application Priority Data
Mar. 18, 2002 (EP) 02076071.6

(51) Int. Cl. G09G 5/10

(52) U.S. Cl. 345/690

(57) ABSTRACT

The invention concerns a device and method for converting and supplying a display driving unit with luminance values as well as a portable electronic device and a display unit including the converting device. The device includes an input (33, 35, 37), which receives a first value representing a luminance level with a first word length. It also includes a conversion unit (34, 36 38), that converts the first value into second and third values. These values together represent the luminance level represented by the first value and have a second word length. The second word length is shorter than the first word length. The device also includes a subfield control unit (32), which supplies the second and third values to the display driving unit during a frame period of the display. The time taken up by each converted value is a subfield of the frame. The subfield of the third value is longer than the subfield of the second value.

### TECHNICAL FIELD

The present invention relates to a method and a device for converting and supplying luminance values to a display control device as well as a portable electronic device and a display unit including such a converting device.

### BACKGROUND OF THE MENTION

In the world of communications and content providers of today there is a trend towards more information to be displayed such as video. This trend is also very much present in the world of mobile communications, where more and more information content demanding applications are being included in the terminals.

The picture format of these applications can have a high resolution, making it possible to display both color and black and white information with fine color resolution. In order to do this, the applications use a fairly big number of bits for each color or gray scale. There is however a problem in that many displays in handheld terminals do not work with the same bit format, which leads to a degradation of resolution when for instance playing video on a display of a portable terminal. It is today normal with a so called 5-6-5 scheme for video applications, where six bits are used for the color green, five bits for red and five bits for blue. In the displays of today there is normally used a lower resolution of 3-3-2 instead, with three bits used for green, three for red and two for blue. There is thus a big degradation of resolution if nothing is done in order to try to raise the resolution, when supplying these higher resolution bit streams to low resolution displays. When the resolution gets lowered there is also a problem with quantization errors, which will be visible on a display if not corrected. There are techniques for reducing the visibility of these errors by error diffusion, like the Floyd-Steinberg algorithm. There also exist a number of techniques to improve the image quality, like dithering. Both have the disadvantage of increasing the noise level.

U.S. Pat. No. 6,094,243 describes a liquid crystal display device where an incoming high resolution bit stream is converted into signals with a lower resolution having different voltages for driving the pixels of a display. The input high-resolution words are here converted to binary data for driving a display. Each bit is here associated with a gray scale value. It is also described how each gray scale bit is provided during a subframe period of a frame for driving the display. The subframes are also described as taking up differing lengths of time of the frame, where the different subframes have the proportions 1:2:4:8 etc. depending on the significance of the bits. The most significant bit is then driven the longest time. This however leads to a large amount of subframes of differing lengths and consequently a rather complex way of driving a display, because of the multitude of subframe lengths. This problem is more clearly understood, when realizing that for a single pixel, the different bits are to be applied on three different conductors to the display. The document then mentions that the above-mentioned proportions between the bits are avoided by instead varying the voltage applied to a subframe in the display. The document therefore describes reduction of the subframe periods of the most significant bits through driving them with higher voltages.

One problem with the document is that it does not really discuss the conversion of a high-resolutionvalue to a low-resolution value for supply to a display driving circuit, but rather a display driving circuit for converting high-resolution values to signals for directly driving a display. This means that the input to the device in the document is converted and directly applied to a display. Often there is a case where one has a driving circuit for a display which requires a word length that is smaller than the word length of the supplied data stream, and in this case the technique described in above mentioned document cannot be used without replacing the existing display driving device with one which can handle such high-resolution values. This might be costly and not in line with other requirements of an apparatus where the display is to be incorporated.

By having an independent converter, the function is optional for a display system. There is thus a need for a device for converting high-resolution luminance values to low resolution luminance values while at the same time retaining the high-resolution information and keep the number of different length subframes low.

From 11^{th} FPD Manufacturing Technology EXPO 6 Conference, Conference Proceedings B3, Jul. 17-19, 2001 it is known to convert a first high resolution luminance value to values of lower resolution, for instance 6-3, 5-3 and 5-2 using scans of equal length of a frame, where a scan is used for providing a low resolution value consisting of a number of bits and a frame is the time required to drive a pixel of the display. In the described conversion scheme four consecutive scans are provided in order to obtain 31 levels corresponding to an input 5-bit word. The values of the four scans are mapped onto the possible original luminance levels according to a conversion table. The lowest possible combination 000 and the highest possible combination 111 for all scans or words are not used here, but otherwise the input levels are mapped onto the scans in growing order. This means that the fourth scan represents the least significant bits of the output words and scan 1 the most significant bits. The four scans are thus used to obtain the original high-resolution information.

### SUMMARY OF THE INVENTION

The present invention seeks to solve the problem of providing a scheme for driving a display, which lowers the number of subfields or scans used and which therefore retains a high quality image for a low performance display at lower cost and energy. The invention is defined by the independent claims. The dependent claims define advantageous embodiments.

According to one aspect of the invention there will be a power saving compared with a four-subfield scheme because each subfield is only clocked once per frame.

The basic idea of the invention is to provide an enhanced bit reduction scheme, which retains the information in an input luminance value while keeping the number of subfields that drive a display low, through providing the subfields with differing lengths.

With the proposed scheme according to the invention, there is no need for using dithering and quantization error reduction.

According to a preferred embodiment of the invention, the number of subfields that drive a display are kept to a minimum, which serves to lower the energy consumption of the device.

Claim 2 provides an enhanced scheme for driving subfields according to the invention.

Claim 3 provides dimensioning of subfields that retains many luminance levels in a conversion scheme according to the invention.

Claim 4 provides a conversion scheme where the subfield lengths are so dimensioned that all input levels can be provided with a minimum of subfields for a certain bit-length reduction.

Claim 6 provides a conversion scheme, where the subfields are dimensioned so that all input levels can be provided with a minimum of subfields for another type of bit-length reduction.

These and other aspects of the invention will in the following be apparent from and elucidated with reference to the embodiments described hereinafter.

### BRIEF DESCRIPTION OF THE DRAWINGS

FIG. 1 shows a portable electronic device in the form of a cellular phone including a display for showing among other things video.

FIG. 2 is a block schematic showing a display unit according to the invention connected to various image sources for driving a pixel in a display.

FIG. 3 is a block schematic showing a device for converting and supplying a display driving unit with luminance values according to the invention.

FIG. 4 shows a first timing diagram for driving a display unit according to a first embodiment of the invention.

FIG. 5 shows a second timing diagram for driving a display unit according to a second embodiment of the invention.

### DETAILED DESCRIPTION OF THE INVENTION

FIG. 1 shows a portable electronic device in the form of a cellular phone 10 having an antenna 14, a baseband module 16 and display 12. The portable electronic devices of today have more and more advanced functions, one of them being video. With these advanced functions there is a need to display information on the display of the phone like video information. However, the displays of today do not normally work with the same type of resolution as many of the video applications provide. It should be understood that a cellular phone is just an example of one type of portable electronic device where there is a need for better resolution in a display.

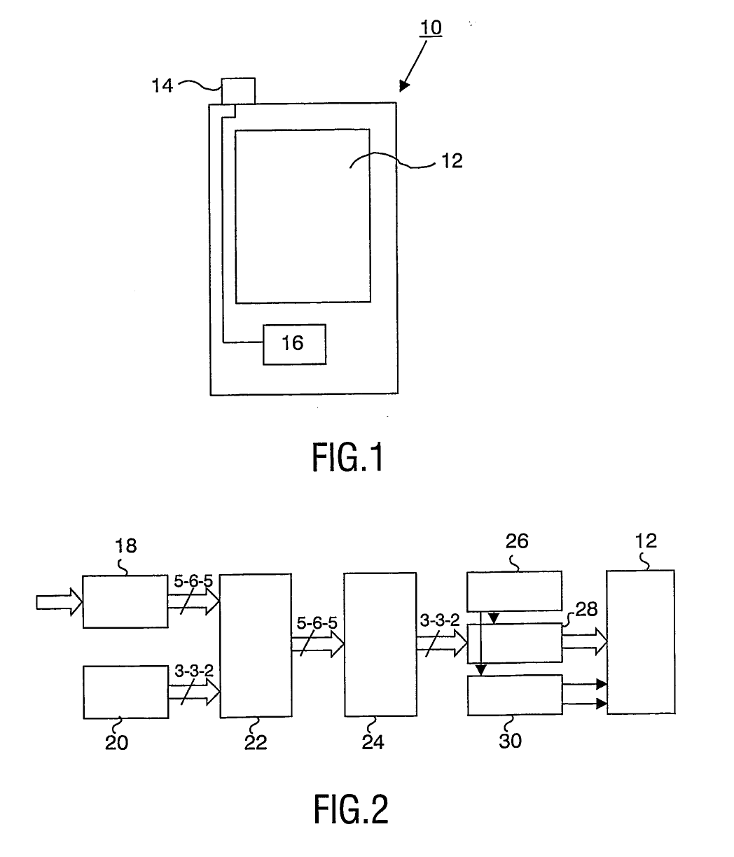

FIG. 2 shows a block schematic of a device for driving a display, which is provided in the phone of FIG. 1. First there is a video source 18, like for instance an MPEG-4 video source, which delivers a video stream or image data. The video source can in itself have received a video stream from a network to which the phone is connected. There is also a data & graphics source 20, which delivers data and graphics. These sources are connected to a video-processing unit 22. As can be seen from FIG. 2, the video source delivers so called 5-6-5 information, that is the colors to be presented on the screen are coded with 5, 6, and 5 bits for red, green and blue, respectively. As is also clear from the figure the data and graphics source delivers data with 3-3-2 resolution, which means that the video source delivers data of higher resolution or contrast. These different types of streams are then processed in the video processing unit 22, which converts the 3-3-2 stream from the data and graphics source 20 to a 5-6-5 stream, by stuffing the least significant bits. Note however that there can be no better contrast because of this. This is only done in order to get uniform handling of different types of data. In the video-processing unit there is also performed video processing like gamma-correction. This is normally a non-linear function x=yⁿ, which converts video data to luminance values.

The video processing unit 22 then submits the high-resolution luminance values (5-6-5) to a data conversion device 24, which converts the high-resolution luminance values to values suitable for supply to a driver of a display (3-3-2). These converted values are then supplied to a display-driving unit comprising a timing and control subunit 26, column drivers 28 and row drivers 30 in order to drive an LCD 12 according to known principles. The display driving circuit can be of a known type, like the LCD driver LH15A1/155N sold by Sharp.

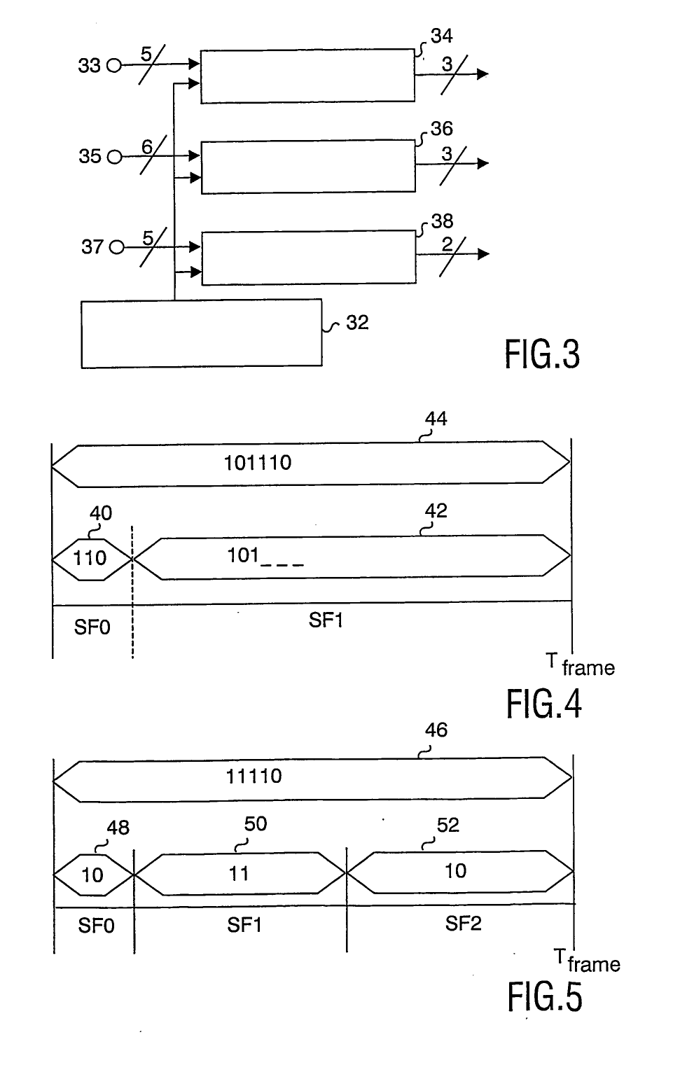

FIG. 3 shows a block schematic of a data conversion device according to the present invention. The data conversion device includes an input for each luminance color value, where an input 33 for the color red can receive luminance values with 5 bits, an input 35 for the color green luminance values with 6 bits and an input 37 for the color blue luminance values with 5 bits. There is a conversion unit 34, 36, 38 in the form a subframe lookup table for each of these colors which converts the input high resolution values to values consisting of fewer bits 3, 3, 2 for red, green and blue, respectively. From the look-up tables these converted luminance values are supplied to the display-driving unit shown in FIG. 2 on separate conductors for each bit. The control and timing of these converted values is made by a subfield control unit 32. How this control is done will be explained shortly.

FIG. 4 shows a timing diagram for driving a certain green pixel of the display 12 during a frame T_{frame}. For comparison only the diagram includes a first digital value 44, which is the input value from the video processing unit 22. Under the input value 44 is shown a second digital value 40 and a third digital value 42. The first digital value is actually not part of the timing, since it is received earlier and then processed in order to produce the second and third values. It is only included for better understanding of the invention. The second value is transmitted during a first subfield SF0 of the transmitting frame T_{frame} and the third value 42 is transmitted during a second subfield SF1, where a frame is the time for driving the pixel of a display.

When a pixel of the display for the color green is to be displayed on the display, the data conversion unit 24 receives a first six-bit luminance value 44 from the video processing unit 22. The first value thus has a word length of six bits. The subfield control unit 32 then looks in a look-up table 36 for converting this value and selects a first and second output value in dependence of the input value. An example of this is table 1 below:

TABLE 1

| Input | SF0 | SF1 | Output |
|---|---|---|---|
| 000000 | 000 | 000 | 000000 |
| 000001 | 001 | 000 | 000001 |
| 000010 | 010 | 000 | 000010 |
| . | . | . | . |
| . | . | . | . |
| . | . | . | . |
| 000111 | 111 | 000 | 000111 |
| 001000 | 000 | 001 | 001000 |
| 001001 | 001 | 001 | 001001 |
| . | . | . | . |
| . | . | . | . |
| . | . | . | . |
| 111110 | 110 | 111 | 111110 |
| 111111 | 111 | 111 | 111111 |

A second luminance value 40 and a third luminance value 42 are chosen from the columns SF1 and SF0 of the table depending on the first value. As can be seen the second and third values have a word length of 3 bits. In FIG. 4 it is seen that an input value of 101110 would get the values 110 for the second value and 101 for the third value 42. The subfield control unit 32 then sends these two values to the display driving unit on three conductors and in the different subfields for driving the pixel. The subfields have different weights. This means that one subfield is supplied a longer time to the display driving unit than the other subfield. In this case SF1 is 8 times longer than SF0. By doing this a logical operation is made on the second and third values and in this case a shift plus add operation is obtained for values having a word length of three bits. This dimensioning is thus equal to shifting the third value 42 by a word length and then adding this value to the second value 40. The pixel in the display is then driven, during a frame T_{frame}, with the second value for a length of time equal to the length of SF0 and the third value is driven for a length of time equal to SF1. Thus the length of SF0 is T_{frame}/9 and SF1 is 8* Tframe/9. When the display is driven with these values during the subfield lengths, the resulting displayed fields are integrated by the human eye and perceptively show extra luminance levels. It can here be seen that the different subfields are weighted so that one of the subfields is longer than the other field and the longer field is associated with the more significant bits of the original luminance values.

The subfield control unit clocks the conductors or lines to the display driving unit only once for each subfield during a frame. Because of this the average clocking frequency is therefore lowered compared with a four-scan or four-subfield scheme. This leads to a halving of the power consumption in relation to the four-scan scheme, which is highly advantageous for portable electronic devices.

For the color red there is a transformation from 5 bits to 3. This transformation is done in the same way as described above. Note however that because of the reduction from 5 to 3 bits in the above-described scheme, there are more values that can be output to the display driver than there are input values. These extra values can be used for sending extra information to the display driver for example for compensation for non-linear behavior of the display.

For the color blue there is a transformation from 5 bits to 2 bits. Here it is not possible to use the scheme above and preserve the image resolution. Instead a scheme shown in FIG. 5 can be used. A first five bit word 46 is transformed into a second two bit word 48, a third two bit word 50 and a fourth two bit word 52, by the lookup table 38 of FIG. 3. The subfield control unit 32 then sees to it that these bits are delivered to the display driver during subfields SF0, SF1 and SF2 of the frame T_{frame}. The subfields SF1 and SF2 are here each four times longer than SF0, which corresponds to a shift of two bits. Thus SF0 is T_{frame}/9. SF1 is 4* T_{frame}/9 and SF2 is 4* T_{frame}/9. SF1 here represents a shift of two bits and an add operation to SF0. However, SF0 and SF1 only make up four of the original five bits. In order to provide the fifth input bit SF2 is provided, where the value 10 is a toggling value, which sets the fifth most significant bit to 1. A value of 00 would set this bit to zero. Also here there are therefore extra levels, which can be used for sending extra information.

Here the subfield control units clocks the conductors or lines to the display driving unit three times during the frame, which also leads to a power saving compared to the four scan method.

Hence the color resolution of the display can be larger than 5-6-5 coding would suggest. When using a higher input resolution or an embedded gamma function, the extra color resolution can be exploited. The subfield driving-scheme can drive up to 6-6-6 levels, which equals 260 K colors.

The system also includes an image frame memory, which works according to known principles and has therefore not been further described in this description.

The invention is also possible to implement for gray scale operation, i.e. without colors. In this case any of the described ways of converting for the colors red, green and blue can be used based on the reduction of number of bits.

A method of implementing the present invention will now be described. First a first high-resolution luminance value is received. Thereafter the first value is converted into second and third low-resolution luminance values. After that the second and third luminance values are supplied to a display driving circuit, during subfields SF0 and SF1, respectively, of a frame for driving the display. Here the subfield during which the third value is supplied is longer than the subfield during which the second value is supplied, and the third value represents at least one more significant bit than the second value and is preferably eight times longer.

An alternative method of supplying luminance values to a display is described now. First a first high-resolution luminance value is received. Thereafter the first value is converted into a second, third and fourth low-resolution luminance values. After that the second, third and fourth luminance values are supplied to a display driving circuit, during subfields SF0, SF1 and SF2, respectively of a frame for driving the display. Here the subfield during which the third value is supplied is longer than the subfield during which the second value is supplied, and the third value represents at least one more significant bit than the second value. The fourth value has a subfield, which is equally long as the subfield of the third value and represents a toggle bit.

Thus a device and method for supplying luminance values to a display have been described. With the proposed scheme according to the invention, there is no need for using dithering and quantization error reduction. A number of subfields are provided with differing lengths depending on how many levels are needed and how many bits need to be reduced. It should be realized that the subfield lengths do not have to be equivalent to a word length according to the invention. They can represent only a shift with a bit, at which time the subfield lengths have a relationship of 2:1. There can for example also be a situation where there are only two subfields having lengths with the proportions 1:4. The relationships of the subfields are selected according to how many bits there is a reduction between from the input luminance value to output luminance values. A toggle bit might be provided when there is not possible to represent all the bits of the input value with two output values. The invention is furthermore not limited to exact correspondence between bits in the first value and bits in the second and third values. There can be a selection in the lookup table of other values, which together at least approximately achieve the desired result of providing the luminance of the first value. Hence gamma conversion and transmission curve compensation can be included in the lookup tables. The invention can furthermore be used for reduction from any bit format to another bit format.

When low power is desired, the transmission of SF0 can be easily skipped, resulting in less addressing cycles, hence less dissipation and lower color resolution is obtained.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Device for converting and supplying a display driving unit with luminance values for driving a pixel in a display, the device comprising:
an input for receiving at least one first digital value representing a luminance level having a first word length made up of a certain number of bits,
at least one conversion unit for converting said first value into at least a second and a third digital value together representing, at least approximately, the luminance level represented by the first digital value, each having a second word length, wherein the second word length is shorter than the first word length, and
a subfield control unit for supplying said second and third values to the display driving unit during a frame period of the display, wherein the time taken up by each of these converted values with said second word length is a subfield of said frame, wherein the subfield control unit is arranged to make the subfield of the third value longer than the subfield of the second value.

2. Device according to claim 1, wherein the conversion unit is arranged to provide the second value with at least one more significant bit than the third value.

3. Device according to claim 1, wherein the subfield lengths are dimensioned for performing logical operations on the second and third values by the display driving unit.

4. Device according to claim 3, wherein the logical operations include shifting one of the second and third values and adding them.

5. Device according to claim 1, wherein the subfield control unit is arranged to clock the display driving unit only once per subfield during a frame.

6. Device according to claim 5, wherein the subfield control units is arranged to change the clock frequency depending on the length of the subfields.

7. Device according to claim 1, wherein the conversion unit is arranged to keep the number of subfields to a minimum needed for representing, at least approximately, the luminance levels that can exist in the first digital value.

8. Device according to claim 1, wherein the conversion unit is arranged to also convert the first value to a fourth value and the subfield control unit is arranged to provide the fourth value with a subfield having the same length as the subfield of the third value.

9. Device according to claim 8, wherein the fourth value is used for toggling the information in the second and third values, for simulating a most significant bit of the first value not provided by the second and third values.

10. Display unit for driving a pixel in a display, comprising:
a display,
a display driving unit, and
a data conversion device as claimed in claim 1.

11. Portable electronic device comprising:
a display,
a display driving unit, and
a data conversion device as claimed in claim 1.

12. Method of converting and supplying a display driving unit with luminance values for driving a pixel in a display, the method comprising the steps of:
receiving at least one first digital value representing a luminance level having a first word length made up of a certain number of bits,
converting said first value into at least a second and a third digital value together representing, at least approximately, the luminance level represented by the first digital value, each having a second word length, wherein the second word length is shorter than the first word length,
supplying said second and third values to the display driving unit during a frame period of the display, wherein the time taken up by each of these converted values with said second word length is a subfield of said frame, wherein the subfield of the second value is longer than the subfield of the third value.
